(19) United States
(12) Patent Application Publication
(10) Pub. No.: US 2005/0250437 A1
(43) Pub. Date: Nov. 10, 2005

(54) Method for contacting at least one module for a wireless radio standards by means of at least one application

(76) Inventors: Henrik Duchstein, Berlin (DE); Janos-Gerold Enderlein, Berlin (DE)

Correspondence Address: BELL, BOYD & LLOYD, LLC, P. O. BOX 1135, CHICAGO, IL, 60690-1135, US

(21) Appl. No.: 10/517,857

(22) PCT Filed: Jun. 6, 2003
(86) PCT No.: PCT/DE03/01968

§ 371 Date: Dec. 14, 2004

(30) Foreign Application Priority Data
Jun. 14, 2002 (DE) 102 27 413.4

(51) Int. Cl. H04H 1/00; H04B 1/38; H04B 1/02; H01R 9/24

(52) U.S. Cl. 455/3.01; 455/91; 455/90.3; 455/128; 439/889; 439/884; 439/865

(57) ABSTRACT

The present invention relates to a method for contacting at least one module for a wireless radio standard via at least one application, according to which one side of the module, which is to be contacted with the application, is provided with contact surfaces while one side of the application, which is to be contacted with the module, is provided with contact surfaces that are able to interact with the contact surfaces of the module, and a connection is established between the respective contact surfaces of the module and the application. The invention also relates to a combination of a module for wireless radio standards and an application. One side of the module, which is to be contacted with the application, includes contact surfaces (planar contact elements while one side of the application, which is to be contacted with the module, includes contact surfaces that can interact with the contact surfaces of the module and can be contacted by the contact surfaces of the module.

### BACKGROUND OF THE INVENTION

The present invention relates to a method for making contact between a module for wire-free radio standards and an application, and to a corresponding combination of a module with an application.

Modules for wire-free radio standards, which have complete GSM/GPRS functionality, so-called wireless modules, are being used in increasing numbers in applications; for example, in mobile computing systems, in PDAs and in portable and lightweight telematics systems. In this case, wireless modules are subject to specific requirements. Firstly, their physical size should be as small as possible in order that they can be used well and occupy little space. Depending on the application, they should be chosen such that height, width and/or length is/are small and appropriate. By way of example, a small physical height is the critical factor for PDAs. Furthermore, in accordance with their specification, the wireless modules must have adequate transmission power. This is particularly due to the fact that the modules are integrated in an application and the connecting lines that are required cause losses. Furthermore, a long operating period is desirable. The wireless modules should be capable of being installed easily and quickly in the various applications, and should be capable of being replaced easily and quickly by other modules with the same or with an upgraded functionality.

Commercially available wireless modules have, until now been connected to an application; for example, to a motherboard of a PDA via plug connectors, such as board-to-board connectors, or via flat ribbon cable connectors. However, this results in a number of disadvantages. The stated connection options consume a large amount of space and are not suitable for miniaturization. Furthermore, the contact is unreliable when using flat ribbon cables. This is due, inter alia, to the desire for further miniaturization and to the reduction which results in the distances between the individual lines in the flat ribbon cable. The reduction in the conductor cross-sections of the connecting lines, which is likewise involved with miniaturization, results in a high electrical contact resistance. In addition, inadequate contact between the module and a heat sink results in a high thermal contact resistance. The ground contact between the module and the application is inadequate, owing to the high resistance of the connecting line. An RF (radio-frequency) connection between a module and an application or an antenna is normally made via a plug and socket system or via a soldered coaxial cable. While the first option is quite costly, the second option (soldering) does not allow thermal effects to be precluded, which can change the behavior of the module.

Since the distance between the contacts on the flat ribbon connector or board-to-board connector is very short, it is difficult to use the contact points as test points while manufacturing the modules. Furthermore, the modules must be manually mounted on an application. Plug insertion, screwing, clamping and soldering processes are normally used for mounting. Owing to this problem, on the one hand, and the inadequate definition and standardization of interfaces for the customer application, on the other hand, a module can be replaced by another module with a different functionality only with major effort. In contrast, it is desirable to have a technical solution which is optimized and standardized not only for the technical parameters, such as low thermal resistance between the heat source on the module and the heat sink on the application, low electrical resistance for the signal and voltage supply between the module and the application, and defined electrical impedance of the RF connections between the module and the application, but also for mounting and adaptation.

The present invention is therefore directed toward a method and a corresponding arrangement which allow contacts to be made as functionally, quickly and simply as possible, while saving as much space as possible.

### SUMMARY OF THE INVENTION

Accordingly, a method is provided for making contact between at least one module for wire-free radio standards and at least one application, with
contact surfaces being provided on a side of the module which is intended to make contact with the application,
contact surfaces which can interact with the contact surfaces of the module being provided on a side of the application which is intended to make contact with the module, and
a connection being produced between the respective contact surfaces of the module and the application.

In one embodiment of the method according to the present invention, a detachable connection is provided between the respective contact surfaces via a mechanical apparatus which allows the module to be pushed into and out of the application, with the contact surfaces which are opposite one another when the module is in the inserted state forming a detachable connection. By way of example, the mechanical apparatus includes a guide rail in the application, in which the module can be pushed in and out in an interlocking manner. Thus the module can be replaced very simply and easily by another module having the same functionality or different functionality. In order to make reliable electrical and thermal contact, mechanical elements such as pins or mechanical springs can be provided on the application side, pressing against the module contacts with an adequate spring force.

In contrast, in another embodiment of the method according to the present invention, a firm connection is provided between the respective contact surfaces. The respective contact surfaces are, in this case, preferably soldered to one another. A further option is to press the two components together.

In a further embodiment of the method according to the present invention, the respective contact surfaces are arranged in the form of a grid or a specific array.

The contact surfaces are preferably formed by a metallic coating with a low electrical and/or thermal resistance. Typical coatings are copper, aluminum and gold alloys.

The present invention furthermore covers a combination, having a module for wire-free radio standards and an application, with the module having contact surfaces on a side which is intended to make contact with the application, and the application having contact surfaces on a side which is intended to make contact with the module, which latter contact surfaces can interact with the contact surfaces of the module and can make contact with them.

In one embodiment of the combination according to the present invention, the respective contact surfaces can be detachably connected to one another.

In yet another embodiment of the combination according to the present invention, the respective contact surfaces may, in contrast to this, be permanently connected to one another. In this case, they can be soldered or crimped to one another.

Furthermore, the respective contact surfaces are preferably arranged in the form of a grid.

Owing to the very small amount of space which is consumed for making contact with the module, the present invention allows a high degree of miniaturization to be achieved. Furthermore, reliable contact is ensured particularly when soldering the respective contact surfaces to one another. Only a very low electrical and thermal contact resistance occurs in this case. In this case, the material system copper/solder (tin/lead system)/copper is used as the electrical/thermal conductor. This results in a very good ground contact between the module and the application. Furthermore, according to the present invention, it is possible to produce a direct contact between the RF connection and an application while, until now, expensive RF connectors have been required for this purpose. Test points can be provided easily. This results in good contact and simple handling during manufacture.

The present invention furthermore provides the capability for automated mounting of the modules on the corresponding applications.

Additional features and advantages of the present invention are described in, and will be apparent from, the following Detailed Description of the Invention and the Figures.

### BRIEF DESCRIPTION OF THE FIGURES

FIG. 1 shows a schematic illustration of the rear face of a module of one embodiment of a combination according to the present invention.

FIG. 2 shows a schematic illustration of one embodiment of a combination according to the present invention, having a module and an application, in which the module and the application can be detachably connected to one another.

### DETAILED DESCRIPTION OF THE INVENTION

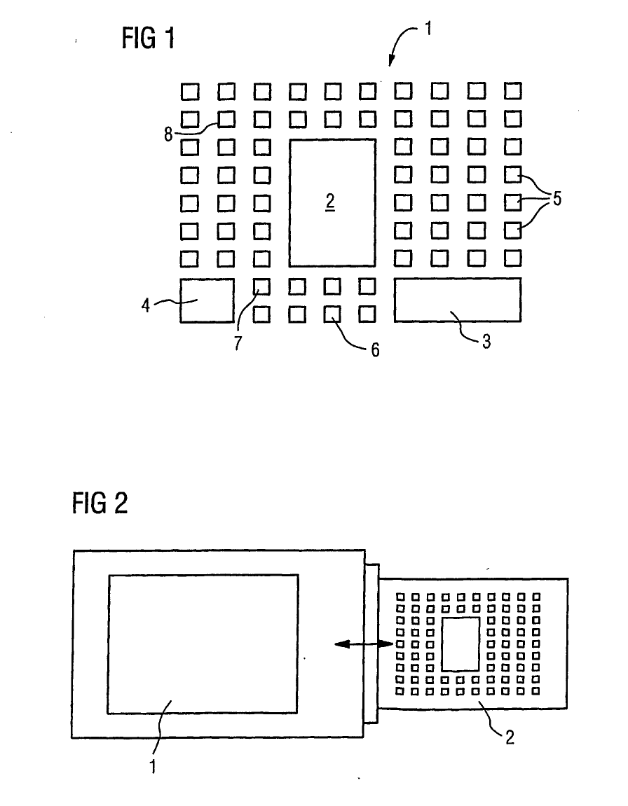

FIG. 1 shows the rear face 1 of a module of a combination according to the present invention, having a module and an application. The arrangement here has a connecting point 2 for a power amplifier. Furthermore, at least one ground contact 3 and at least one connecting point 4 are provided for a voltage supply. The smaller, rectangular contact surfaces represent interfaces 5 for an application with which contact is intended to be made. Alternatively, test points 6 for manufacture and test points 7 for development can be provided under the smaller rectangular contact surfaces. Furthermore, an RF contact point 8 may be provided.

FIG. 2 shows a mechanical apparatus for holding a module 2 in an application 1, as well as a module 2 which can be pushed into and out of this apparatus or the application 1. The mechanical apparatus includes, by way of example, a guide rail in the application 1, in which the module 2 can be displaced in an interlocking manner. When the module 2 is in the pushed-in state, the contact surfaces of the module 2 and the contact surfaces of the application 1 are opposite one another.

Although the present invention has been described with reference to specific embodiments, those of skill in the art will recognize that changes may be made thereto without departing from the spirit and scope of the present invention as set forth in the hereafter appended claims.

1-10. (canceled)

11. A method for making contact between at least one module for wire-free radio standards and at least one application, the method comprising:
providing contact surfaces on a side of the module which is intended to make contact with the application; and
providing contact surfaces, which may interact with the contact surfaces of the module, on a side of the application which is intended to make contact with the module, wherein the respective contact surfaces of the module and application are formed by a metallic coating with a low resistance, the low resistance being at least one of electrical and thermal, and a connection is produced between the respective contact surfaces of the module and the application.

12. A method for making contact between at least one module for wire-free radio standards and at least one application as claimed in claim 11, further comprising providing a detachable connection between the respective contact surfaces of the module and the application via a mechanical apparatus which allows the module to be replaced by pushing the module in and out.

13. A method for making contact between at least one module for wire-free radio standards and at least one application as claimed in claim 11, wherein a firm connection is provided between respective contact surfaces of the module and the application.

14. A method for making contact between at least one module for wire-free radio standards and at least one application as claimed in claim 13, wherein the respective contact surfaces of the module and the application are one of soldered together and pressed together.

15. A method for making contact between at least one module for wire-free radio standards and at least one application as claimed in claim 11, wherein the respective contact surfaces of the module and the application are arranged in grid form.

16. A combination of at least one module for wire-free radio standards and at least one application, comprising:
a module for wire-free radio standards; and
an application;
wherein the module includes contact surfaces on a side which is intended to make contact with the application, and the application includes contact surfaces on a side which is intended to make contact with the module, the respective contact surfaces of the module and the application interacting with each other and making contact therewith, with the respective contact surfaces of the module and the application being formed by a metallic coating with a low resistance, the resistance being at least one of electrical and thermal.

17. A combination of at least one module for wire-free radio standards and at least one application as claimed in claim 16, wherein the respective contact surfaces of the module and the application may be detachably connected to one another.

18. A combination of at least one module for wire-free radio standards and at least one application as claimed in claim 16, wherein the respective contact surfaces of the module and the application may be permanently connected to one another.

19. A combination of at least one module for wire-free radio standards and at least one application as claimed in claim 18, wherein the respective contact surfaces of the module and the application may be soldered to one another.

20. A combination of at least one module for wire-free radio standards and at least one application as claimed in claim 16, wherein the respective contact surfaces of the module and the application are arranged in grid form.
